(19) United States
(12) Patent Application Publication
(10) Pub. No.: US 2020/0257471 A1
(43) Pub. Date: Aug. 13, 2020

(54) CONTROL APPARATUS AND CONTROL METHOD

(71) Applicant: CANON KABUSHIKI KAISHA, Tokyo (JP)

(72) Inventor: Wataru Ochiai, Tokyo (JP)

(21) Appl. No.: 16/773,054

(22) Filed: Jan. 27, 2020

(30) Foreign Application Priority Data
Feb. 7, 2019 (JP) 2019-020850

(51) Int. Cl. G06F 3/06

(52) U.S. Cl. CPC G06F 3/0659; G06F 3/0644; G06F 3/0673; G06F 3/0604

(57) ABSTRACT

A control apparatus controls access from a plurality of masters to a memory. The apparatus comprises: an acquisition unit configured to acquire a plurality of access requests from the plurality of masters; a selection unit configured to select a scheme to be used from a plurality of different schemes for determining an access sequence in accordance with a state of a master concerning satisfaction of a performance requirement; and an execution unit configured to execute a plurality of acquired access requests in a sequence according to a selected scheme.

### BACKGROUND OF THE INVENTION

### Field of the Invention

The present invention relates to a control apparatus and a control method.

### Description of the Related Art

In recent years, with improvements in the function and performance of electronic devices, the number of masters that access the DRAM in an LSI has been increasing. In addition, the band required for the DRAM has been increasing. Each master has its own performance requirements, and is expected to process a specific amount of data in a specific period. A failure to process such data may cause problems in terms of function and performance.

Accordingly, a bus system is required to control access to the DRAM so as to satisfy the performance requirements of each master. As a technique for satisfying the performance requirements of each master, the techniques disclosed in Japanese Patent Laid-Open Nos. 2012-168773, 2011-095966, and 2006-260472 have been proposed.

According to the technique disclosed in Japanese Patent Laid-Open No. 2012-168773, access is given the allowable time until the completion of access by each master, and the allowable time decreases with the lapse of time. An arbiter completes processing within each allowable time by preferentially processing accesses in increasing order of allowable times.

According to the technique disclosed in Japanese Patent Laid-Open No. 2011-095966, an arbiter measures the amount of data processed in a predetermined period for each master, and masks access from a master that has reached an upper limit, thereby allocating bands required for the respective masters.

According to the technique disclosed in Japanese Patent Laid-Open No. 2006-260472, when executing access, an arbiter selects and executes an access requiring a minimum overhead in a memory, thereby optimizing the band of the memory.

### SUMMARY OF THE INVENTION

The techniques disclosed in Japanese Patent Laid-Open Nos. 2012-168773 and 2011-095966, however, cannot optimize the band of the memory even though they can satisfy the performance requirements of each master. Disabling optimization of the band of the memory will prolong the use time of the memory and consume power more than necessary.

The technique disclosed in Japanese Patent Laid-Open No. 2006-260472 cannot always satisfy the performance requirements of each master even though it can optimize the band of the memory.

An aspect of the present invention provides an access control technique that can optimize band of a memory while satisfying the performance requirements of each master.

As a means for solving the above problems, an aspect of the present invention has the following arrangement.

A control apparatus that controls access from a plurality of masters to a memory, the apparatus comprising: an acquisition unit configured to acquire a plurality of access requests from the plurality of masters; a selection unit configured to select a scheme to be used from a plurality of different schemes for determining an access sequence in accordance with a state of a master concerning satisfaction of a performance requirement; and an execution unit configured to execute a plurality of acquired access requests in a sequence according to a selected scheme.

According to an aspect of the present invention, it is possible to optimize the band of a memory while satisfying the performance requirements of each master.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing the function and arrangement of a bus system according to the first embodiment;

FIG. 2 is a block diagram showing the function and arrangement of a sequence control circuit in FIG. 1;

FIGS. 3A, 3B, and 3C are graphs showing the relationships between the performance requirements of masters and urgency degrees;

FIG. 4 is a view showing an example of the definition of overheads before and after accesses;

FIG. 5 is a timing chart showing how access sequence control schemes are dynamically switched;

FIGS. 6A, 6B, 6C, 6D, 6E, 6F, and 6G are tables showing internal states at the respective timings in FIG. 5;

FIG. 7 is a block diagram showing the function and arrangement of a bus system according to the second embodiment;

FIG. 8 is a timing chart showing how access sequence control schemes are dynamically switched; and

FIGS. 9A, 9B, 9C, 9D, 9E, 9F, 9G, and 9H are tables showing internal states at the respective timings in FIG. 8.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

A bus system according to an embodiment has a plurality of different access sequence control schemes for determining the sequence or order of accesses from masters to a memory. The bus system selects an access sequence control scheme to be used from a plurality of access sequence control schemes in accordance with urgency degrees. Accordingly, when urgent handling is required to satisfy the performance requirements of a master, it is possible to use an access sequence control scheme corresponding to the urgency. In ordinary times, it is possible to use, for example, an access sequence control scheme for optimizing the memory band.

This makes it possible to optimize the band of the memory while satisfying the performance requirements of each master, and hence to quickly complete overall processing. As a result, the use time of the memory decreases, and power saving can be achieved. Alternatively, new processing may be added to improve function and performance.

### First Embodiment

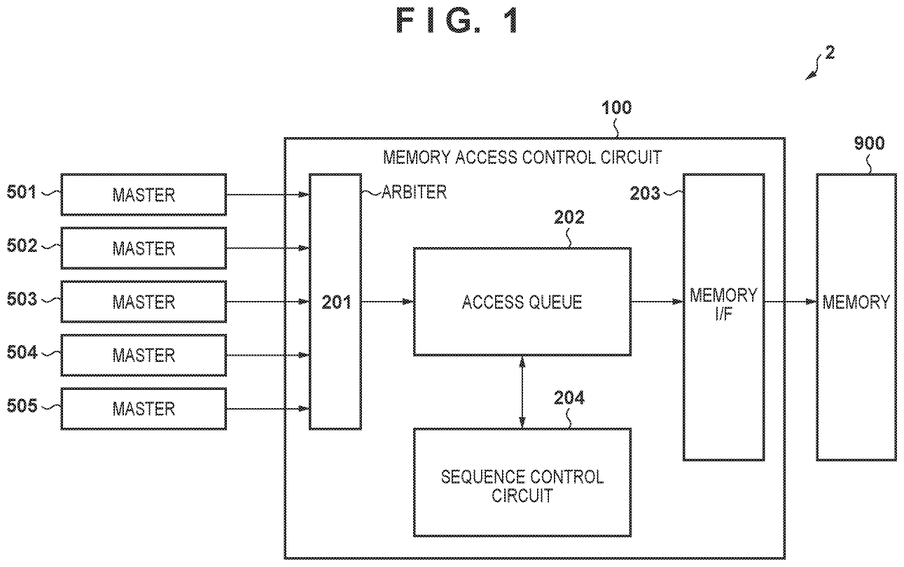

FIG. 1 is a block diagram showing the function and arrangement of a bus system 2 according to the first embodiment. The bus system 2 includes a plurality of (five in the case shown in FIG. 1) masters 501, 502, 503, 504, and 505, a memory access control circuit 100, and a memory 900. The bus system 2 is used in, for example, a multifunction peripheral having a printing function and a scanning function. Each master reads data from the memory 900 and writes data in the memory 900 by accessing the memory 900 via the memory access control circuit 100.

The memory 900 is a DRAM. An overhead is generated when pages are switched or when direction is changed between read and write operations. In another embodiment, the memory may be an SRAM, flash memory, HDD, SSD, or the like, and an overhead may be properly defined in accordance with the type of memory.

The memory access control circuit 100 controls access from the plurality of masters 501 to 505 to the memory 900. The memory access control circuit 100 includes an arbiter 201, an access queue 202, a memory IF 203, and a sequence control circuit 204.

A master accesses the memory 900 by transmitting an access request to the memory 900. The arbiter 201 arbitrates access from the plurality of masters 501 to 505 to the memory 900. The arbiter 201 obtains a plurality of access requests from the plurality of masters 501 to 505 to the memory 900.

The access queue 202 holds a plurality of access requests associated with a plurality of accesses arbitrated by the arbiter 201. The access queue 202 transmits the access request selected by the sequence control circuit 204 to the memory IF 203 under the control of the sequence control circuit 204. The access queue 202 holds master identifiers for identifying the masters 501 to 505 as transmission sources of the access requests and the directions of accesses to the memory 900. The access queue 202 also holds the banks and page numbers of the memory 900 which correspond to access targets corresponding to the access requests and the elapsed times since the access requests were held.

The sequence control circuit 204 selects an access sequence control scheme to be used from a plurality of different access sequence control schemes for determining the sequence of accesses to the memory 900 in accordance with the state of each master which is associated with the satisfaction of performance requirements. The sequence control circuit 204 selects an access request as an execution target from a plurality of access requests held in the access queue 202 in accordance with the selected access sequence control scheme.

The memory IF 203 executes a plurality of access requests acquired by the arbiter 201 in a sequence complying with the access sequence control scheme selected by the sequence control circuit 204. The memory IF 203 transmits the access request as an execution target received from the access queue 202 to the memory 900 upon converting the access request into a form that satisfies the specifications of the memory 900. In addition, the memory IF 203 notifies the access queue 202 so as to inhibit it from transmitting a next access request until the next access request can be executed.

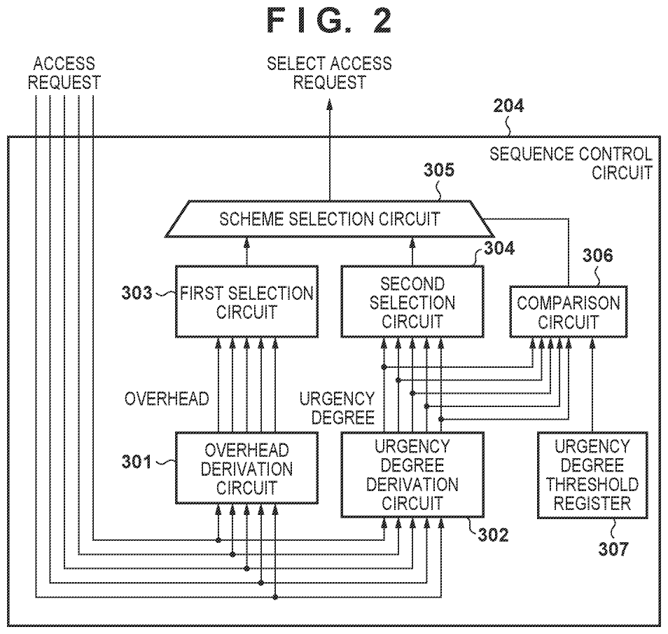

FIG. 2 is a block diagram showing the function and arrangement of the sequence control circuit 204 in FIG. 1. The sequence control circuit 204 includes an overhead derivation circuit 301, an urgency degree derivation circuit 302, a first selection circuit 303, a second selection circuit 304, a scheme selection circuit 305, a comparison circuit 306, and an urgency degree threshold register 307.

The overhead derivation circuit 301 derives, for each access request held in the access queue 202, an overhead generated when the access request is executed. This overhead is derived based on an overhead generated when pages in the memory 900 are switched and an overhead when the direction of access to the memory 900 is changed between read and write operations. The overhead derivation circuit 301 outputs the overhead derived for each access request to the first selection circuit 303.

The overhead derivation circuit 301 manages, for each bank constituting the memory 900, the history of access to the bank and derives an overhead when pages are switched for each bank. The overhead derivation circuit 301 manages the direction of access to the memory 900 which has most recently been executed, and derives an overhead when the direction of access is changed. The overhead derivation circuit 301 outputs, for each access request held in the access queue 202, an overhead associated with the access request. That is, the overhead derivation circuit 301 outputs a larger one (or the largest value) of an overhead generated when pages are switched and an overhead generated when the direction of access is changed as an overhead associated with the access request.

The first selection circuit 303 selects one access request from a plurality of access requests held in the access queue 202 based on an overhead base scheme for determining the sequence of accesses in accordance with an overhead. More specifically, the first selection circuit 303 generates a selection signal for selecting an access request with the smallest overhead derived by the overhead derivation circuit 301, and outputs the signal to the scheme selection circuit 305.

The urgency degree derivation circuit 302 derives an urgency degree corresponding to the satisfaction of the performance requirements of a master as a transmission source of each access request held in the access queue 202. The urgency degree derivation circuit 302 outputs the urgency degree derived for each access request to the second selection circuit 304 and the comparison circuit 306.

The urgency degree derivation circuit 302 outputs the urgency degree of a master corresponding to each access request held in the access queue 202 as the urgency degree of the access request. The urgency degree derivation circuit 302 derives an urgency degree based on the state of progress of data processing in a predetermined period for each master. More specifically, the urgency degree derivation circuit 302 manages the access periods and the amounts of accessed data of the masters 502 to 505, and determines an urgency degree by monitoring whether an expected amount of accessed data has been able to be processed in a predetermined period. The urgency degree derivation circuit 302 outputs the urgency degree of the master specified by the master identifier of each access request held in the access queue 202 as the urgency degree of the access request.

The urgency degree derivation circuit 302 derives an urgency degree for the master 501 based on the remaining time allowed for the satisfaction of the performance requirements of the master 501. More specifically, the urgency degree derivation circuit 302 determines an urgency degree concerning an access request from the master 501 by monitoring whether the wait time of the access request has exceeded a preset allowable remaining time.

The second selection circuit 304 selects one access request from a plurality of access requests held in the access queue 202 in accordance with the urgency degree base scheme for determining the sequence of accesses according to an urgency degree. More specifically, the second selection circuit 304 generates a selection signal for selecting an access request corresponding to the largest urgency degree derived by the urgency degree derivation circuit 302, and outputs the signal to the scheme selection circuit 305.

The urgency degree threshold register 307 holds a predetermined urgency degree threshold.

The comparison circuit 306 compares the urgency degree derived by the urgency degree derivation circuit 302 with the threshold held in the urgency degree threshold register 307. The comparison circuit 306 outputs a comparison result signal representing the comparison result to the scheme selection circuit 305.

The scheme selection circuit 305 selects the urgency degree base scheme when the urgency degree derived by the urgency degree derivation circuit 302 satisfies a predetermined criterion; otherwise, selects an overhead base scheme. The scheme selection circuit 305 selects the selection signal output from the second selection circuit 304 when the comparison result signal received from the comparison circuit 306 represents that the urgency degrees derived by the urgency degree derivation circuit 302 for the respective access requests include an access request with an urgency degree equal to or more than the threshold. The scheme selection circuit 305 then outputs the selected selection signal to the access queue 202. If the scheme selection circuit 305 does not select the selection signal output from the second selection circuit 304, the following processing is performed. That is, if the urgency degrees derived for the respective access requests by the urgency degree derivation circuit 302 include no urgency degree equal to or more than the threshold, the scheme selection circuit 305 selects the selection signal output from the first selection circuit 303. The selected selection signal is then output to the access queue 202.

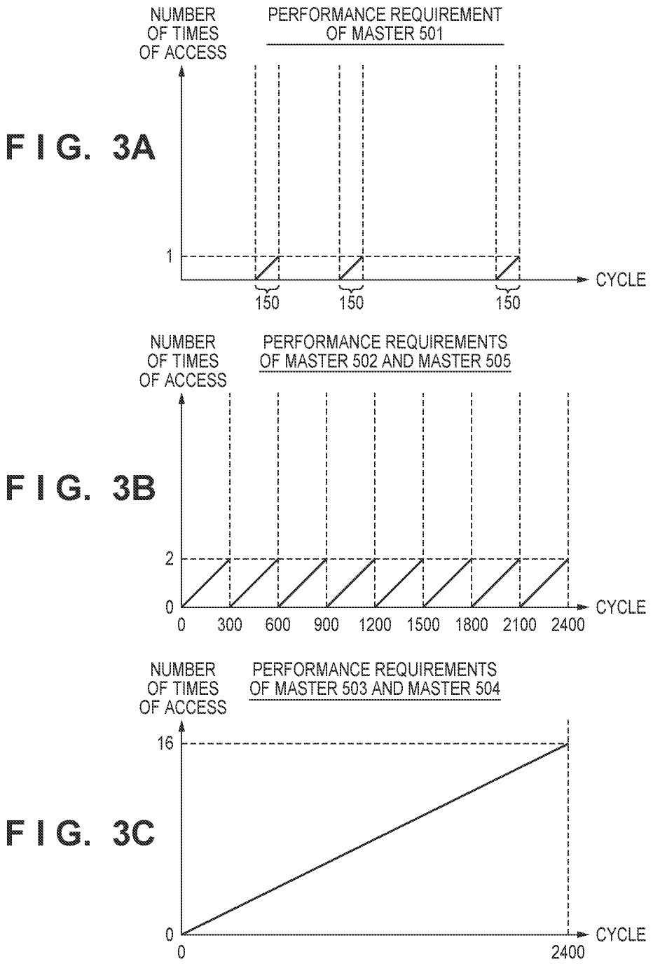

FIGS. 3A, 3B, and 3C show the relationships between the performance requirements of the masters 501 to 505 and urgency degrees. For the sake of simplicity, assume that the masters 501 to 505 exchange the same amount of data in one access operation. Assume also that each master consumes eight cycles per access.

Referring to FIG. 3A, access from the master 501 is expected to be processed in a short time. This master irregularly makes such access. Accordingly, assume that an urgency degree (to be referred to as QoS hereinafter) at the start of access is 0, and changes to 1 after 150 cycles.

Referring to FIG. 3B, when the masters 502 and 505 make accesses, it is expected to repeatedly process a predetermined amount of data in a relatively short period. In this case, it is expected that two accesses can be processed in 300 cycles. Assume that the value of (the number of times of access processed/the elapsed time) is derived per cycle, and QoS is 0 when the value is equal to or more than (2/300)=(1/150), and is 1 when the value is less than (2/300)=(1/150).

Referring to FIG. 3C, when the masters 503 and 504 make accesses, it is expected to repeatedly process a predetermined amount of data in a relatively long period. In this case, it is expected that 16 accesses can be processed in 2,400 cycles. Assume that the value of (the number of times of access processed/the elapsed time) is derived per cycle, and QoS is 0 when the value is equal to or more than (16/2400)=(1/150), and is 1 when the value is equal to or less than (16/2400)=(1/150).

This embodiment will exemplify a case in which the urgency degree threshold is 1. That is, when there is an access request with QoS of 1, the sequence control circuit 204 executes access sequence control using the urgency degree base scheme, whereas when there is no access with QoS of 1, the sequence control circuit 204 executes access sequence control using the overhead base scheme.

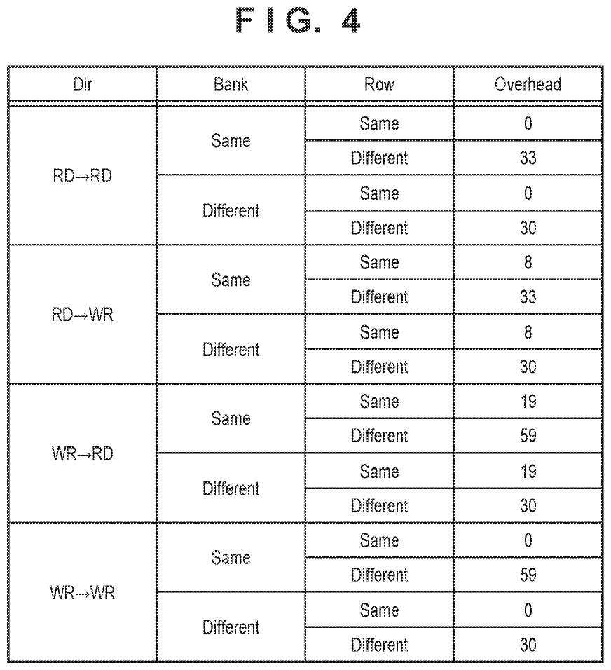

FIG. 4 shows an example of the definition of overheads before and after accesses. “Dir” represents the relationship between most recently executed access and access to be selected. “RD” and “WR” respectively represent read and write operations. The direction from read to read and other cases will be described with reference to the case of the direction from read to read. “Bank” represents whether a most recently executed access coincides in bank with an access to be selected. “Same” and “Different” respectively represent that such accesses coincide in bank and do not coincide in bank. When accesses coincide in bank, “Row” represents whether a most recently executed access coincides in page with an access to be selected. If the accesses coincide in page, the overhead is defined as 0 cycle. If the accesses do not coincide in page, the overhead is defined as 33 cycles.

If the accesses do not coincide in bank (Different), “Row” represents whether a most recently executed access to the same bank coincides in page with an access to be selected. If the accesses coincide in page, the overhead is defined as 0 cycle. If the accesses do not coincide in page, the overhead is defined as 30 cycles.

“Bank”, “Row”, and “Overhead” in the directions from read to write, from write to read, and from write to write have similar meanings to those in the direction from read to read.

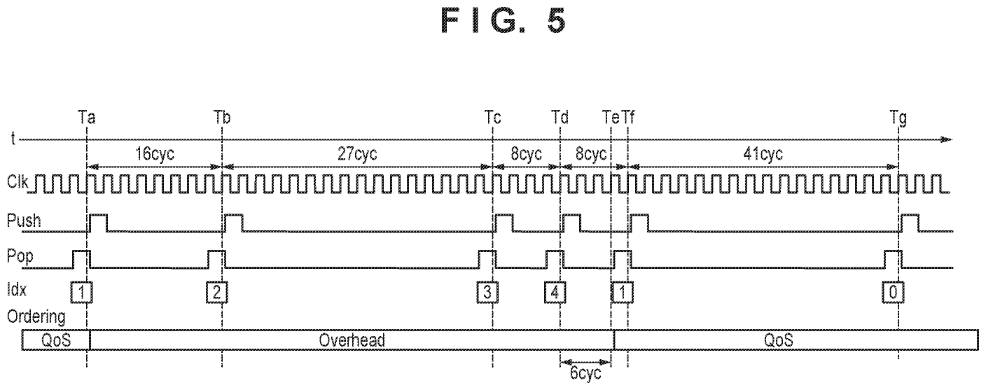

FIG. 5 is a timing chart showing how access sequence control schemes are dynamically switched. “Push” represents the timing when a new access request is held in the access queue 202. “Pop” represents the timing when an access request is selected from the access queue 202 and executed. “Idx” represents which access request in the access queue 202 is executed. “Ordering” indicates “QoS” when the sequence control circuit 204 executes access sequence control using the urgency degree base scheme, and “Overhead” when the sequence control circuit 204 executes access sequence control using the overhead base scheme.

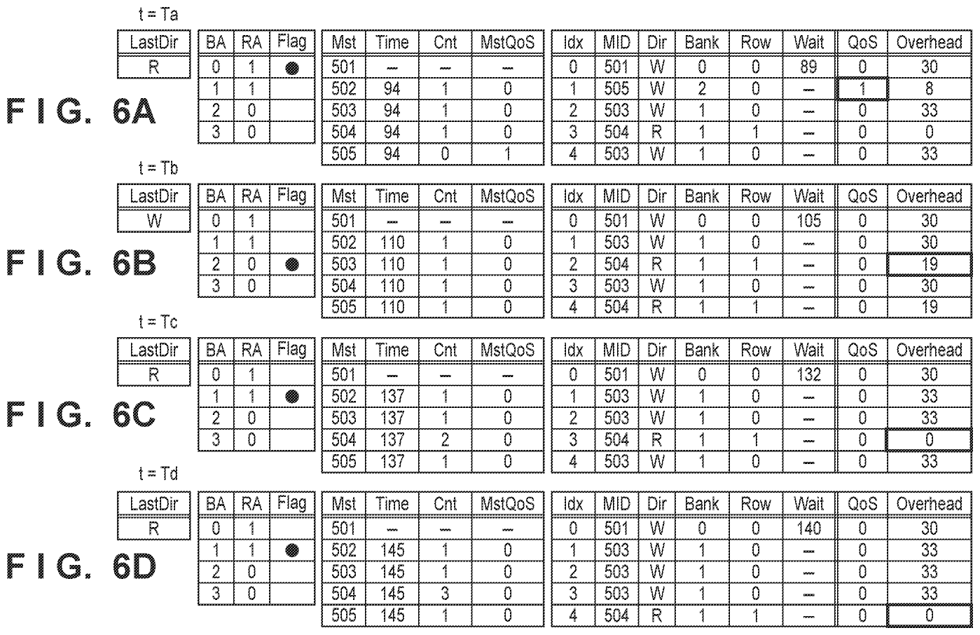

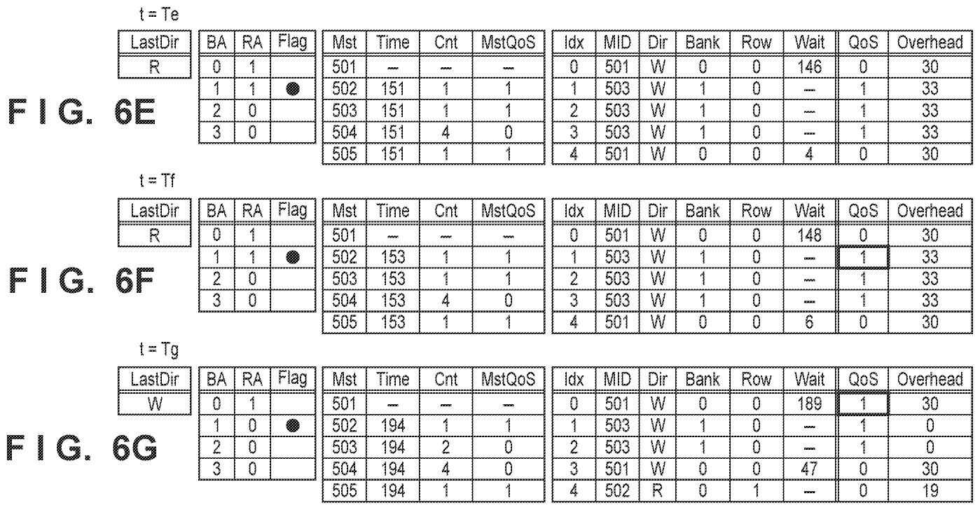

FIGS. 6A, 6B, 6C, 6D, 6E, 6F, and 6G respectively show internal states at the respective timings in FIG. 5. FIGS. 6A, 6B, 6C, 6D, 6E, 6F, and 6G respectively show various types of internal states at t=Ta, Tb, Tc, Td, Te, Tf, and Tg in FIG. 5. The respective items will be sequentially described from left to right. Assume that the access queue 202 has five rows. Assume also that the access queue 202 is of a type in which when an access request in the access queue 202 is selected, the access requests held behind the selected access request shift forward by one, and a new access request is always added to the tail.

LastDir: the direction of access managed by the overhead derivation circuit 301 and most recently executed with respect to the memory 900.

Flag: the history of access for each bank managed by the overhead derivation circuit 301. More specifically, an activated page number (RA) is held for each bank (BA), and the flag is set (registered) in a most recently accessed bank.

Mst, Time, Cnt, MstQoS: a measurement period (Time), an access success count (Cnt), and an urgency degree (MstQoS) concerning each master (Mst), all of which are managed by the urgency degree derivation circuit 302.

Idx, MID, Dir, Bank, Row, Wait: a number (Idx) indicating the position of each access request in the access queue 202, a master identifier (MID) specifying a master as a transmission source of each access request, the direction (Dir) of each access request, a bank (Bank), a page number (Row), and an elapsed time (Wait), all of which are held in the access queue 202.

QoS, Overhead: the urgency degree (QoS) of each access request output from the urgency degree derivation circuit 302 and the overhead of each access request output from the overhead derivation circuit 301.

Referring to FIG. 6A, when t=Ta, an access request with Idx=1 in the access queue 202 is selected. At this time, because (Cnt/Time)=(0/94)<(1/150) concerning the master 505, the urgency degree derivation circuit 302 sets MstQoS=1 for the master 505. Because (Cnt/Time)=(1/94)>(1/150) concerning the masters 502 to 504, the urgency degree derivation circuit 302 sets MstQoS=0 for the masters 502 to 504. In addition, the urgency degree derivation circuit 302 outputs MstQoS of a master corresponding to “MID” of each access request as QoS of each access request. Furthermore, because an access request with Idx=0 corresponding MID=501 exhibits Wait<150, the urgency degree derivation circuit 302 sets QoS=0 with respect to the access request with Idx=0.

The urgency degree threshold register 307 outputs threshold=1 to the comparison circuit 306. The comparison circuit 306 compares threshold=1 received from the urgency degree threshold register 307 with QoS of each access request received from the urgency degree derivation circuit 302. The comparison circuit 306 outputs the comparison result as a comparison result signal to the scheme selection circuit 305.

Because the comparison result signal received from the comparison circuit 306 indicates the presence of an access request with QoS=1, the scheme selection circuit 305 selects an output from the second selection circuit 304, and notifies the access queue 202 of the output. The second selection circuit 304 generates a selection signal for selecting the access request with Idx=1 exhibiting QoS=1. The access queue 202 takes out the access request with Idx=1. Because the overhead of this access request is 8, the next access request can be selected at t=Tb after 8+8=16 cycles.

In the next cycle, the urgency degree derivation circuit 302 sets Cnt=1 and MstQoS=0 concerning the master 505. In addition, because the comparison result signal indicates the absence of an access request with QoS=1, the scheme selection circuit 305 selects an output from the first selection circuit 303.

Referring to FIG. 6B, when t=Tb, an access request with Idx=2 in the access queue 202 is selected. At this time, because (Cnt/Time)=(1/110)>(1/150) concerning the masters 502 to 505, the urgency degree derivation circuit 302 sets MstQoS=0 for the masters 502 to 505. The urgency degree derivation circuit 302 outputs MstQoS of a master corresponding to “MID” of each access request as QoS of each access request. Furthermore, because an access request with Idx=0 corresponding MID=501 exhibits Wait<150, the urgency degree derivation circuit 302 sets QoS=0 with respect to the access request with Idx=0.

Because the comparison result signal received from the comparison circuit 306 indicates the absence of an access request with QoS=1, the scheme selection circuit 305 selects an output from the first selection circuit 303, and notifies the access queue 202 of the output. The first selection circuit 303 selects an access request with Idx=2 or Idx=4 exhibiting minimum “Overhead”. Assume that in this case, the first selection circuit 303 selects the access request with Idx=2 exhibiting smaller “Idx”. The first selection circuit 303 generates a selection signal for selecting the access request with Idx=2. The access queue 202 takes out the access request with Idx=2 in accordance with the selection signal. Because the overhead of this access request is 19, the next access request can be selected at t=Tc after 8+19=27 cycles.

Referring to FIG. 6C, when t=Tc, an access request with Idx=3 in the access queue 202 is selected. At this time, because (Cnt/Time)=(1/137)>(1/150) concerning the masters 502 to 505, the urgency degree derivation circuit 302 sets MstQoS=0 for the masters 502 to 505. The urgency degree derivation circuit 302 outputs MstQoS of a master corresponding to “MID” of each access request as QoS of each access request. Furthermore, because an access request with Idx=0 corresponding MID=501 exhibits Wait<150, the urgency degree derivation circuit 302 sets QoS=0 with respect to the access request with Idx=0.

Because the comparison result signal received from the comparison circuit 306 indicates the absence of an access request with QoS=1, the scheme selection circuit 305 selects an output from the first selection circuit 303, and notifies the access queue 202 of the output. The first selection circuit 303 generates a selection signal for selecting an access request with Idx=3 exhibiting minimum “Overhead”. The access queue 202 takes out the access request with Idx=3 in accordance with the selection signal. Because the overhead of this access request is 0, the next access request can be selected at t=Td after 8+0=8 cycles.

Referring to FIG. 6D, when t=Td, an access request with Idx=4 in the access queue 202 is selected. At this time, because (Cnt/Time)=(1/145)>(1/150) concerning the masters 502 to 505, the urgency degree derivation circuit 302 sets MstQoS=0 for the masters 502 to 505. The urgency degree derivation circuit 302 outputs MstQoS of a master corresponding to “MID” of each access request as QoS of each access request. Furthermore, because an access request with Idx=0 corresponding MID=501 exhibits Wait<150, the urgency degree derivation circuit 302 sets QoS=0 with respect to the access request with Idx=0.

Because the comparison result signal received from the comparison circuit 306 indicates the absence of an access request with QoS=1, the scheme selection circuit 305 selects an output from the first selection circuit 303, and notifies the access queue 202 of the output. The first selection circuit 303 generates a selection signal for selecting an access request with Idx=4 exhibiting minimum “Overhead”. The access queue 202 takes out the access request with Idx=4 in accordance with the selection signal. Because the overhead of this access request is 0, the next access request can be selected at t=Tf after 8+0=8 cycles.

Referring to FIG. 6E, when t=Te, because (Cnt/Time)=(1/151)<(1/150) concerning the masters 502, 503, and 505, the urgency degree derivation circuit 302 sets MstQoS=1 for the masters 502, 503, and 505. The urgency degree derivation circuit 302 outputs MstQoS of a master corresponding to “MID” of each access request as QoS of each access request. Furthermore, because an access request with Idx=0 corresponding MID=501 exhibits Wait<150, the urgency degree derivation circuit 302 sets QoS=0 with respect to the access request with Idx=0.

Because the comparison result signal received from the comparison circuit 306 indicates the absence of an access request with QoS=1, the scheme selection circuit 305 selects an output from the second selection circuit 304.

Referring to FIG. 6F, when t=Tf, an access request with Idx=1 in the access queue 202 is selected. At this time, because (Cnt/Time)=(1/153)<(1/150) concerning the masters 502, 503, and 505, the urgency degree derivation circuit 302 sets MstQoS=1 for the masters 502, 503, and 505. The urgency degree derivation circuit 302 outputs MstQoS of a master corresponding to “MID” of each access request as QoS of each access request. Furthermore, because an access request with Idx=0 corresponding MID=501 exhibits Wait<150, the urgency degree derivation circuit 302 sets QoS=0 with respect to the access request with Idx=0.

Because the comparison result signal received from the comparison circuit 306 indicates the absence of an access request with QoS=1, the scheme selection circuit 305 selects an output from the second selection circuit 304, and notifies the access queue 202 of the output. The second selection circuit 304 selects an access request with Idx=1, Idx=2, or Idx=3 exhibiting QoS=1. Assume that in this case, the second selection circuit 304 selects an access request with Idx=1 exhibiting minimum “Idx”. The second selection circuit 304 generates a selection signal for selecting the access request with Idx=1. The access queue 202 takes out the access request with Idx=1 in accordance with the selection signal. Because the overhead of this access request is 33, the next access request can be selected at t=Tg after 8+33=41 cycles.

Referring to FIG. 6G, when t=Tg, an access request with Idx=0 in the access queue 202 is selected. Because (Cnt/Time)=(1/194)<(1/150) concerning the masters 502 and 505, the urgency degree derivation circuit 302 sets MstQoS=1 for the masters 502 and 505. The urgency degree derivation circuit 302 outputs MstQoS of a master corresponding to “MID” of each access request as QoS of each access request. Furthermore, because an access request with Idx=0 corresponding MID=501 exhibits Wait>150, the urgency degree derivation circuit 302 sets QoS=1 with respect to the access request with Idx=0.

Because the comparison result signal received from the comparison circuit 306 indicates the presence of an access request with QoS=1, the scheme selection circuit 305 selects an output from the second selection circuit 304, and notifies the access queue 202 of the output. The second selection circuit 304 generates a selection signal for selecting the access request with Idx=0 exhibiting QoS=1 and minimum “Idx”. The access queue 202 takes out the access request with Idx=0 in accordance with the selection signal. Because the overhead of this access request is 30, the next access request can be selected after 8+30=38 cycles.

The bus system 2 according to this embodiment can dynamically switch between access sequence control using urgency degrees and access sequence control using overhead in accordance with urgency degrees. This makes it possible to optimize the band of the memory while satisfying the performance requirements of each master.

The bus system 2 according to this embodiment can also optimize the band of the memory while satisfying the performance requirements of each master by dynamically switching between a plurality of sequence control schemes in accordance with the urgency degree of memory access which dynamically changes.

### Second Embodiment

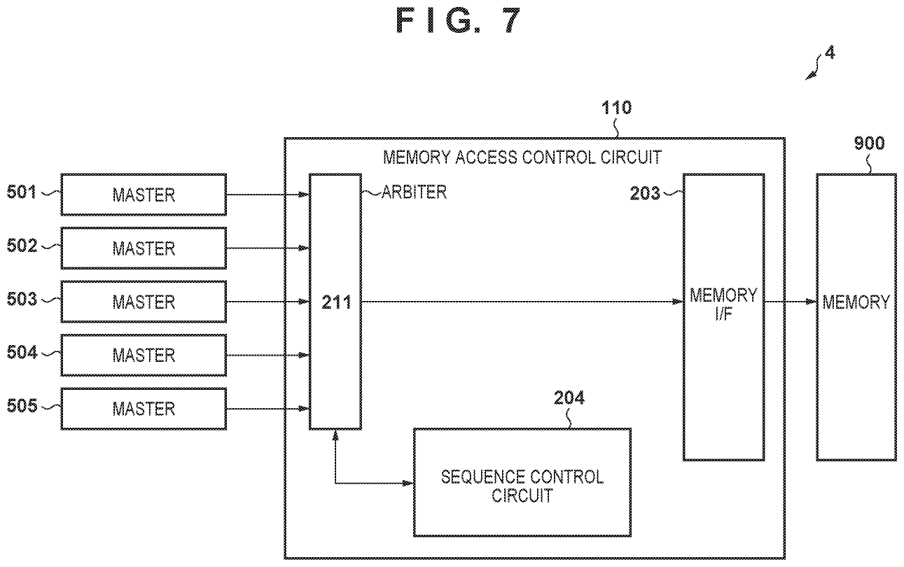

FIG. 7 is a block diagram showing the function and arrangement of a bus system 4 according to the second embodiment. The bus system 4 includes a plurality of (five in the case shown in FIG. 7) masters 501, 502, 503, 504, and 505, a memory access control circuit 110, and a memory 900. The memory access control circuit 110 includes an arbiter 211, a memory IF 203, and a sequence control circuit 204. The masters 501 to 505, the memory IF 203, the memory 900, and the sequence control circuit 204 are similar to those shown in FIG. 1.

The memory access control circuit 110 uses the sequence control circuit 204 for arbitration performed by the arbiter 211. The sequence control circuit 204 selects an access request to be executed from a plurality of access requests handled by the arbiter 211. The arbiter 211 transmits the selected access request to the memory IF 203.

The arbiter 211 holds, for each received access request, a master identifier for identifying a corresponding one of the masters 501 to 505 as a transmission source of the access request, the direction of access to the memory 900, a bank and a page number in the memory 900 as an access target of the access request, and the elapsed time since the access request was received. Assume that the relationships between the performance requirements of the masters 501 to 505 and urgency degrees are the same as those shown in FIGS. 3A, 3B, and 3C, and the definition of overhead based on the before-after relationship between accesses is the same as shown in FIG. 4.

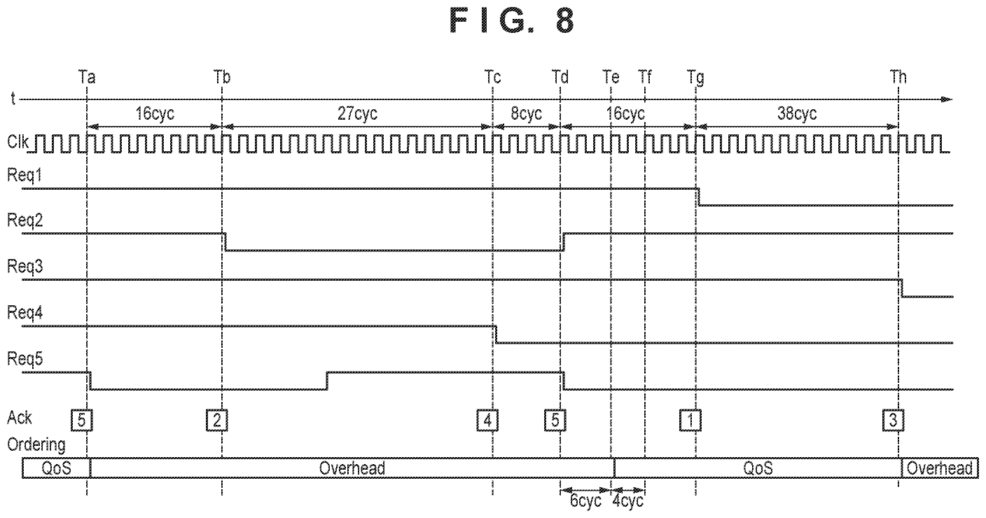

FIG. 8 is a timing chart showing how access sequence control schemes are dynamically switched. “Req1” to “Req5” respectively represent the presence/absence of access requests from the masters 501 to 505, with H level representing the presence of an access request, and L level representing the absence of an access request. “Ack” represents a specific master from which the arbiter 211 has received an access request. “Ordering” represents which access sequence control, of access sequence control using the urgency degree base scheme and access sequence control using the overhead base scheme, the sequence control circuit 204 executes.

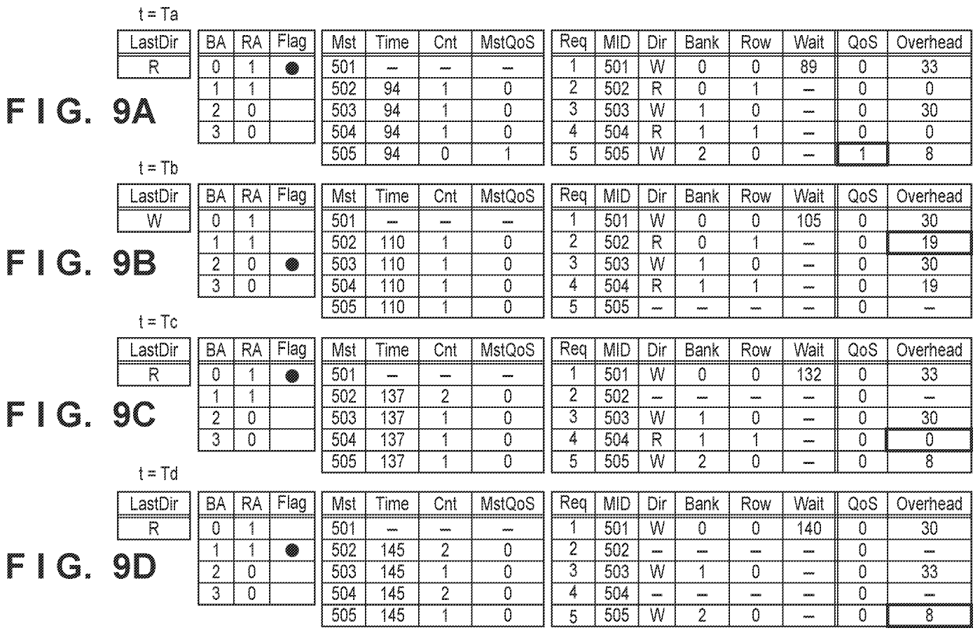

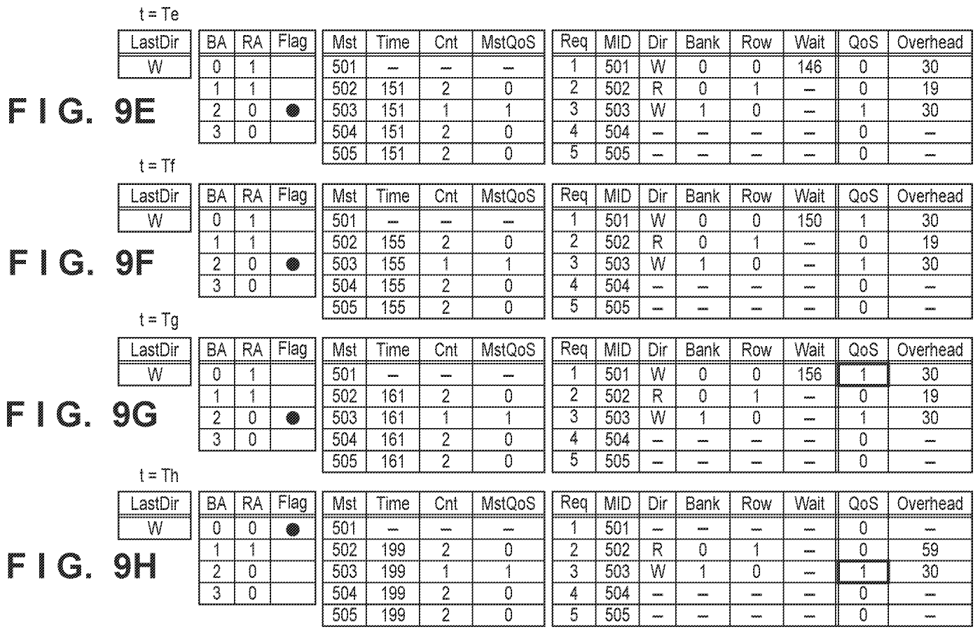

FIGS. 9A, 9B, 9C, 9D, 9E, 9F, 9G, and 9H respectively show internal states at the respective timings in FIG. 8. FIGS. 9A, 9B, 9C, 9D, 9E, 9F, 9G, and 9H respectively show various types of internal states at t=Ta, Tb, Tc, Td, Te, Tf, Tg, and Th in FIG. 8. The respective items will be sequentially described from left to right.

LastDir: the direction of access managed by an overhead derivation circuit 301 and most recently executed with respect to the memory 900.

Flag: the history of access for each bank managed by the overhead derivation circuit 301. More specifically, an activated page number (RA) is held for each bank (BA), and the flag is set (registered) in a most recently accessed bank.

Mst, Time, Cnt, MstQoS: a measurement period (Time), an access success count (Cnt), and an urgency degree (MstQoS) concerning each master (Mst), all of which are managed by an urgency degree derivation circuit 302.

Req, MID, Dir, Bank, Row, Wait: The contents of an access request received by the arbiter 211. More specifically, the contents include the Req number (Req) shown in FIG. 8, a master identifier (MID) for specifying a master as a transmission source of the access request corresponding to “Req”, the direction (Dir) of the access request, a bank (Bank), a page number (Row), and an elapsed time (Wait).

QoS, Overhead: the urgency degree (QoS) of each access request output from the urgency degree derivation circuit 302 and the overhead of each access request output from the overhead derivation circuit 301.

Referring to FIG. 9A, when t=Ta, then Ack=5. Accordingly, an access request from the master 505 is selected. At this time, because (Cnt/Time)=(0/94)<(1/150) concerning the master 505, the urgency degree derivation circuit 302 sets MstQoS=1 for the master 505. Because (Cnt/Time)=(1/94)>(1/150) concerning the masters 502 to 504, the urgency degree derivation circuit 302 sets MstQoS=0 for the masters 502 to 504. In addition, the urgency degree derivation circuit 302 outputs MstQoS of a master corresponding to each “Req” as QoS of each “Req”. Furthermore, because an access request with Req=1 corresponding MID=501 exhibits Wait<150, the urgency degree derivation circuit 302 sets QoS=0.

Because the comparison result signal received from a comparison circuit 306 indicates the presence of an access request with QoS=1, a scheme selection circuit 305 selects an output from a second selection circuit 304, and notifies the arbiter 211 of the output. The second selection circuit 304 generates a selection signal for selecting the access request with Req=5 exhibiting QoS=1. The arbiter 211 outputs Ack=5 in accordance with the selection signal. Because the overhead of this access request is 8, the next access request can be selected at t=Tb after 8+8=16 cycles.

In the next cycle, the urgency degree derivation circuit 302 sets MstQoS=0 concerning the master 505. In addition, because the comparison result signal received from the comparison circuit 306 indicates the absence of an access request with QoS=1, the scheme selection circuit 305 selects an output from a first selection circuit 303.

Referring to FIG. 9B, when t=Tb, then Ack=2. Accordingly, an access request from the master 502 is selected. At this time, because (Cnt/Time)=(0/110)>(1/150) concerning the masters 502 to 505, the urgency degree derivation circuit 302 sets MstQoS=0 for the masters 502 to 505. In addition, the urgency degree derivation circuit 302 outputs MstQoS of a master corresponding to “MID” of each “Req” as QoS of each “Req”. Furthermore, because an access request with Req=1 corresponding MID=501 exhibits Wait<150, the urgency degree derivation circuit 302 sets QoS=0.

Because the comparison result signal received from a comparison circuit 306 indicates the absence of an access request with QoS=1, the scheme selection circuit 305 selects an output from the first selection circuit 303, and notifies the arbiter 211 of the output. The first selection circuit 303 selects an access request with Req=2 or Req=4 exhibiting minimum “Overhead”. In this case, the first selection circuit 303 generates a selection signal for selecting the access request with Req=2 exhibiting minimum “Req”. The arbiter 211 outputs Ack=2 in accordance with the selection signal. Because the overhead of this access request is 19, the next access request can be selected at t=Tc after 8+19=27 cycles.

Referring to FIG. 9C, when t=Tc, then Ack=4. Accordingly, an access request from the master 504 is selected. At this time, because (Cnt/Time)=(0/137)>(1/150) concerning the masters 502 to 505, the urgency degree derivation circuit 302 sets MstQoS=0 for the masters 502 to 505. In addition, the urgency degree derivation circuit 302 outputs MstQoS of a master corresponding to “MID” of each “Req” as QoS of each “Req”. Furthermore, because an access request with Req=1 corresponding MID=501 exhibits Wait<150, the urgency degree derivation circuit 302 sets QoS=0.

Because the comparison result signal received from the comparison circuit 306 indicates the absence of an access request with QoS=1, the scheme selection circuit 305 selects an output from the first selection circuit 303, and notifies the arbiter 211 of the output. The first selection circuit 303 generates a selection signal for selecting the access request with Req=4 exhibiting minimum “Overhead”. The arbiter 211 outputs Ack=4 in accordance with the selection signal. Because the overhead of this access request is 0, the next access request can be selected at t=Td after 8+0=8 cycles.

Referring to FIG. 9D, when t=Td, then Ack=5. Accordingly, an access request from the master 505 is selected. At this time, because (Cnt/Time)=(0/145)>(1/150) concerning the masters 502 to 505, the urgency degree derivation circuit 302 sets MstQoS=0 for the masters 502 to 505. In addition, the urgency degree derivation circuit 302 outputs MstQoS of a master corresponding to “MID” of each “Req” as QoS of each “Req”. Furthermore, because an access request with Req=1 corresponding MID=501 exhibits Wait<150, the urgency degree derivation circuit 302 sets QoS=0.

Because the comparison result signal received from the comparison circuit 306 indicates the absence of an access request with QoS=1, the scheme selection circuit 305 selects an output from the first selection circuit 303, and notifies the arbiter 211 of the output. The first selection circuit 303 generates a selection signal for selecting the access request with Req=5 exhibiting minimum “Overhead”. The arbiter 211 outputs Ack=5 in accordance with the selection signal. Because the overhead of this access request is 8, the next access request can be selected at t=Tg after 8+8=16 cycles.

Referring to FIG. 9E, when t=Te, the urgency degree derivation circuit 302 sets MstQoS=1 for the master 503 because (Cnt/Time)=(1/151)<(1/150) concerning the master 503.

Referring to FIG. 9F, when t=Tf, the access request with Req=1 exhibiting MID=501 satisfies Wait>150. Accordingly, the urgency degree derivation circuit 302 sets QoS=1 with respect to the access request with Req=1.

Referring to FIG. 9G, when t=Tg, then Ack=1. Accordingly, an access request from the master 501 is selected. At this time, the urgency degree derivation circuit 302 sets MstQoS of the master 503 to MstQoS=1 because (Cnt/Time)=(0/161)<(1/150) concerning the master 503. The urgency degree derivation circuit 302 sets MstQoS of each of the masters 502, 504, and 505 to MstQoS=0 because (Cnt/Time)=(2/161)>(1/150) concerning each of the masters 502, 504, and 505. In addition, the urgency degree derivation circuit 302 outputs MstQoS of a master corresponding to each “Req” as QoS of “Req”. Furthermore, because an access request with Req=1 corresponding MID=501 exhibits Wait>150, the urgency degree derivation circuit 302 sets QoS=1.

Because the comparison result signal received from the comparison circuit 306 indicates the presence of an access request with QoS=1, the scheme selection circuit 305 selects an output from the second selection circuit 304, and notifies the arbiter 211 of the output. The second selection circuit 304 selects an access request with Req=1 or Req=3 exhibiting QoS=1. In this case, the second selection circuit 304 generates a selection signal for selecting the access request with Req=1 exhibiting minimum “Req”. The arbiter 211 outputs Ack=1 in accordance with the selection signal. Because the overhead of this access request is 30, the next access request can be selected at t=Th after 8+30=38 cycles.

Referring to FIG. 9H, when t=Th, then Ack=3. Accordingly, an access request from the master 503 is selected. At this time, because (Cnt/Time)=(0/199)<(1/150) concerning the master 503, the urgency degree derivation circuit 302 sets MstQoS=1 for the master 503. The urgency degree derivation circuit 302 sets MstQoS of each of the masters 502, 504, and 505 to MstQoS=0 because (Cnt/Time)=(2/199)>(1/150) concerning each of the masters 502, 504, and 505.

Because the comparison result signal received from the comparison circuit 306 indicates the presence of an access request with QoS=1, the scheme selection circuit 305 selects an output from the second selection circuit 304, and notifies the arbiter 211 of the output. The second selection circuit 304 generates a selection signal for selecting the access request with Req=3 exhibiting QoS=1. The arbiter 211 outputs Ack=3 in accordance with the selection signal. Because the overhead of this access request is 30, the next access request can be selected after 8+30=38 cycles.

In the next cycle, the urgency degree derivation circuit 302 sets MstQoS=0 concerning the master 503. In addition, the scheme selection circuit 305 selects an output from the first selection circuit 303 because the comparison result signal received from the comparison circuit 306 represents the absence of an access request with QoS=1.

As described above, the bus system 4 according to this embodiment can dynamically switch between access sequence control using urgency degrees and access sequence control using overheads. This makes it possible to optimize the band of the memory while satisfying the performance requirements of each master.

The arrangements and operations of the bus systems according to the embodiments have been described above. Those skilled in the art understand that these embodiments are exemplary, and that the combinations of the respective constituent elements and the respective processes can be variously modified, and the resultant modifications are included in the spirit and scope of the present invention.

The first and second embodiments each have exemplified the case in which an urgency degree is generated from the elapsed time of access and the execution state of access. However, this is not exhaustive. For example, it is possible to use an arbitrary index indicating the urgency degree of access that dynamically changes.

The first and second embodiments each have exemplified the case in which an overhead is defined or generated by referring to the table in FIG. 4 while comparing with most recently executed access. However, this is not exhaustive, and an overhead may be defined in another aspect. For example, an overhead derived by the overhead derivation circuit 301 may include an overhead generated when the memory 900 is refreshed.

In the first and second embodiments, assuming that the amount of data processed in one access remains the same, an access success count (Cnt) is used as an index indicating the amount of data processed. However, this is not exhaustive. Even if such assumption does not hold, for example, the amount of processed data, which is the amount of actually processed data, may be used in place of or in addition to an access success count (Cnt). In this case, the urgency degree derivation circuit 302 updates the elapsed time (corresponding to “Time”) every time N cycles (N≥1) elapse, updates the amount of processed data when an access request is selected as an execution target, and derives an urgency degree from the ratio between the amount of processed data and the elapsed time.

Alternatively, the urgency degree derivation circuit 302 updates the elapsed time (corresponding to “Time”) every time N cycles (N≥1) elapse, and updates the amount of processed data when data transfer is completed upon execution of an access request. The urgency degree derivation circuit 302 may derive an urgency degree from the ratio between the amount of processed data and the elapsed time. Alternatively, the urgency degree derivation circuit 302 may update the allowable remaining time every time N cycles (N≥1) elapse and derive an urgency degree from the updated remaining time.

The first and second embodiments each have exemplified the case in which as a plurality of schemes for determining an access sequence, the urgency degree base scheme and the overhead base scheme are used. However, this is not exhaustive. In addition to or in place of these two schemes, other schemes such as FIFO, FILO, LIFO, round robin, random, and pseudo random may be used.

The present invention is not limited to the above-described embodiments, and various changes and modifications can be made within the spirit and scope of the present invention. Therefore, to apprise the public of the scope of the present invention, the following claims are made.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-020850, filed Feb. 7, 2019, which is hereby incorporated by reference herein in its entirety.

What is claimed is:

1. A control apparatus that controls access from a plurality of masters to a memory, the apparatus comprising:
an acquisition unit configured to acquire a plurality of access requests from the plurality of masters;
a selection unit configured to select a scheme to be used from a plurality of different schemes for determining an access sequence in accordance with a state of a master concerning satisfaction of a performance requirement; and
an execution unit configured to execute a plurality of acquired access requests in a sequence according to a selected scheme.

2. The apparatus according to claim 1, further comprising an urgency degree derivation unit configured to derive an urgency degree concerning satisfaction of a performance requirement of each of the masters,
wherein the selection unit selects a scheme in accordance with a derived urgency degree.

3. The apparatus according to claim 2, further comprising an overhead derivation unit configured to derive an overhead generated when each of access requests is executed,
wherein the plurality of different schemes include a first scheme for determining an access sequence in accordance with urgency degrees and a second scheme for determining an access sequence in accordance with an overhead, and
the selection unit selects the first scheme if a derived urgency degree satisfies a predetermined criterion and selects another scheme including the second scheme if the first scheme is not selected.

4. The apparatus according to claim 2, wherein the urgency degree derivation unit derives an urgency degree based on a state of progress of data processing in a predetermined period with respect to each master.

5. The apparatus according to claim 2, wherein the urgency degree derivation unit derives, for each master, an urgency degree based on an allowable remaining time for satisfaction of a performance requirement of the master.

6. The apparatus according to claim 3, wherein the overhead derived by the overhead derivation unit is an overhead generated when pages in the memory are switched.

7. The apparatus according to claim 3, wherein the overhead derived by the overhead derivation unit is an overhead generated when a direction of access to the memory changes between write and read.

8. The apparatus according to claim 3, wherein the overhead derived by the overhead derivation unit is an overhead generated when the memory is refreshed.

9. The apparatus according to claim 4, wherein the urgency degree derivation unit updates an elapsed time every time N cycles (N≥1) elapse, updates an amount of processed data when an access request is selected as an execution target, and derives an urgency degree from a ratio between the amount of processed data and the elapsed time.

10. The apparatus according to claim 4, wherein the urgency degree derivation unit updates an elapsed time every time N cycles (N≥1) elapse, updates an amount of processed data when data transfer is completed upon execution of an access request, and derives an urgency degree from a ratio between the amount of processed data and the elapsed time.

11. The apparatus according to claim 5, wherein the urgency degree derivation unit updates an allowable remaining time every time N cycles (N≥1) elapse, and an urgency degree is derived from the updated remaining time.

12. A control method of controlling access from a plurality of masters to a memory, the method comprising:
acquiring a plurality of access requests from the plurality of masters;
selecting a scheme to be used from a plurality of different schemes for determining an access sequence in accordance with a state of a master concerning satisfaction of a performance requirement; and
executing a plurality of acquired access requests in a sequence according to a selected scheme.

13. The method according to claim 12, further comprising deriving an urgency degree concerning satisfaction of a performance requirement of each of the masters,
wherein in the selection, a scheme is selected in accordance with a derived urgency degree.

14. The method according to claim 13, further comprising deriving an overhead generated when each of access requests is executed,
wherein the plurality of different schemes include a first scheme for determining an access sequence in accordance with urgency degrees and a second scheme for determining an access sequence in accordance with an overhead, and
in the selection, the first scheme is selected if a derived urgency degree satisfies a predetermined criterion, and another scheme including the second scheme is selected if the first scheme is not selected.

15. The method according to claim 13, wherein in the derivation of the urgency degree, an urgency degree is derived based on a state of progress of data processing in a predetermined period with respect to each master.

16. The method according to claim 13, wherein in the derivation of the urgency degree, an urgency degree is derived for each master based on an allowable remaining time for satisfaction of a performance requirement of the master.

17. The method according to claim 14, wherein the overhead derived by the overhead derivation unit is an overhead generated when pages in the memory are switched.

18. The method according to claim 14, wherein the overhead derived by the overhead derivation unit is an overhead generated when a direction of access to the memory changes between write and read.

19. The method according to claim 14, wherein the overhead derived by the overhead derivation unit is an overhead generated when the memory is refreshed.

20. The method according to claim 15, wherein in the derivation of the urgency degree, an elapsed time is updated every time N cycles (N≥1) elapse, an amount of processed data is updated when an access request is selected as an execution target, and an urgency degree is derived from a ratio between the amount of processed data and the elapsed time.
